(19) United States
(12) Patent Application Publication
(10) Pub. No.: US 2009/0320820 A1
(43) Pub. Date: Dec. 31, 2009

(54) GEMSTONE WATERBATH DRILL

(76) Inventor: John J. Sinisi, Warminster, PA (US)

Correspondence Address: GREGORY J. GORE, 70 WEST OAKLAND AVENUE, SUITE 316, DOYLESTOWN, PA, 18901, US

(21) Appl. No.: 12/146,022

(22) Filed: Jun. 25, 2008

(51) Int. Cl. B28D 5/02; B23B 41/16; B23B 45/02

(52) U.S. Cl. 125/30.01; 408/16; 408/56; 408/67; 408/236; 408/6

(57) ABSTRACT

A gemstone drill is of the drill press type which includes a motor suspended and slidably affixed between upstanding vertical telescoping rods. A drill bit is affixed to a spindle which is a direct extension of the motor shaft which is in parallel alignment with the rods. A body of the motor includes a cylindrical spindle housing extending downwardly from the bottom of the motor body adjacent the drill bit. The rods are extensible from tower sleeves mounted directly to a base which has a top support surface enclosed by a transparent containment cover. The door is moveable between open and closed positions to gain access to a clamping mechanism releasably attached to the support surface that holds the stone to be drilled. The containment cover, when closed, includes a circular aperture at the top which closely receives the spindle housing.

### FIELD OF THE INVENTION

The present invention relates to the drill press type for drilling gemstones and rocks. More specifically, it relates to a rock driller in which the stone is clamped in a water bath.

### BACKGROUND OF THE INVENTION

It is known to provide a drill press which supports a workpiece in a water bath such as disclosed in U.S. Pat. No. 4,052,132. Such devices are large, expensive industrial machines and are not available for use by the ordinary man or children. There is a great need in the craft industry for a drill which will economically drill holes in jewelry stones so that they may be strung or laced. To date, there has not been a successful attempt to satisfy this need in the craft arts.

The other patent documents which show different features of the gemstone drill are as follows: U.S. Pat. No. 5,163,792 includes a guide clamp apparatus including a vice grip with a pilot. U.S. Pat. No. 5,310,296 discloses a plunge router with an elastically mounted bushing and a two-post fixture. Drilling enclosures which include guard doors with safety switches include U.S. Pat. Nos. 4,226,322 and 6,987,241. U.S. Pat. No. 7,182,720 discloses a machine tool in which a spindle moves through a seal of the workpiece enclosure. U.S. Pat. No. 4,790,695 discloses a modular drill jig with bushings in the clamp. U.S. Pat. No. 3,944,845 discloses a liquid-level shutoff control which will inhibit connectivity if liquid is not present.

### SUMMARY OF THE INVENTION

In order to meet the needs in the art, the present gemstone drill has been invented. It is very economical and inexpensive to produce and operates safely so that it may even be operated by a child. The drill is of the drill-press type which includes a motor suspended and slidably affixed between upstanding vertical telescoping rods. A drill bit is affixed to a spindle which is a direct extension of the motor shaft which is in parallel alignment with the rods. A body of the motor includes a cylindrical spindle housing extending downwardly from the bottom of the motor body adjacent the drill bit. The rods are extensible from tower sleeves mounted directly to a base which has a top support surface enclosed by a transparent containment cover. A door of the containment cover is hinged at one side next to one of the sleeves. The door is moveable between open and closed positions to gain access to a clamping mechanism releasably attached to the support surface that holds the stone to be drilled. The containment cover, when closed, includes a circular aperture at the top which closely receives the spindle housing. By these mechanical relations, the motor-driven drill bit may be moved vertically downward into a work area and withdrawn as desired by the operator while the work area is isolated from the surrounding environment.

A clamp supported on the top of the base and lying within the containment cover holds the workpiece stone. The top of the clamp includes a plate having a pilot bushing which receives a shank of the drill spindle at a point before the drill bit tip engages the workpiece. The work clamp is retained in a water basin and includes liquid-sensing electrodes so that without sufficient water in the reservoir the drill motor will not operate. As a further safety measure, a safety switch positioned at the point of the containment door closure senses the position of the door such that the drill motor will not operate unless the door is fully closed.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top left rear isometric view of the invention.

FIG. 2 is a top left front isometric view of the invention with the containment cover door in the open position.

FIG. 3 is a top left front isometric view showing the releaseable attachment of the reservoir basin to the support base.

FIG. 4 is a top right isometric assembly view of the clamp means.

FIG. 5 is a top right front assembly view of the clamp means and the water basin.

### DESCRIPTION OF THE PREFERRED EMBODIMENT

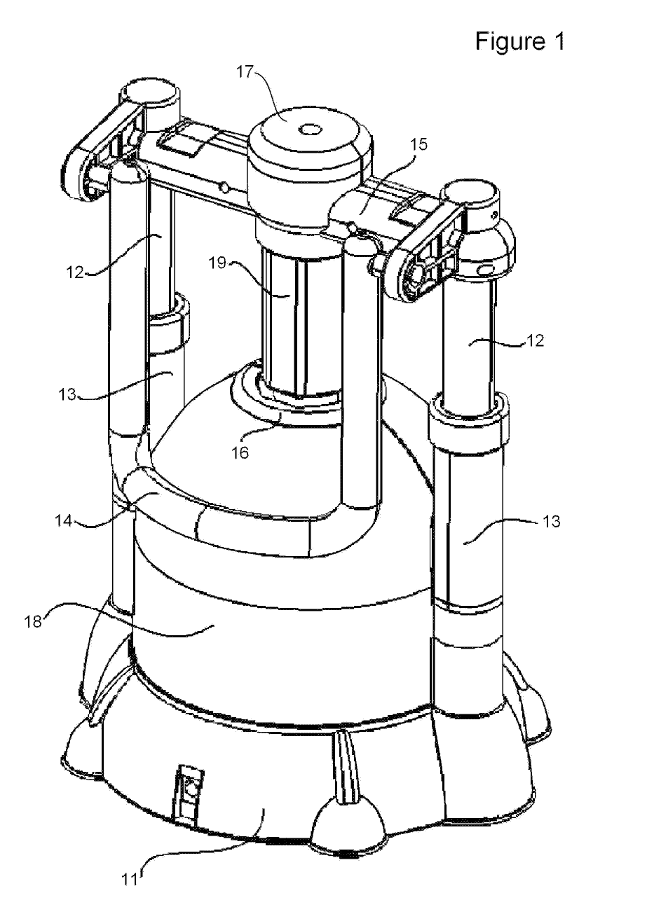

Referring now to FIG. 1, the basic components of the drill press of the invention are shown from the rear view. A pair of vertically extending tower sleeves 13 are affixed to a base 11. A frame 15 which holds a drill 17 positional in the center of motor frame 15 which includes laterally extending arms mounted to rods 12 telescopically extend from the tower sleeves 13. The frame 15 is biased upwardly by spring means within the tower sleeves 13 (not shown). The drill 17 includes a motor having a spindle housing 19 that is substantially cylindrical and closely received within a circular opening 16 at the top of a dome shaped containment cover 18. A handle 14 is rotatably affixed to the frame 15 and provides movement between stored and operable positions. In this Figure, the handle 14 is shown in its stored position compactly resting against the top of the containment cover 18. The cover is preferably transparent. By the above-described mechanical relations it will be understood that the drill 17 is vertically reciprocal within the containment cover such that a work area under the containment cover is isolated from the surrounding environment. The cover prevents any flying of debris or spattering of water from the drilling process from reaching the operator.

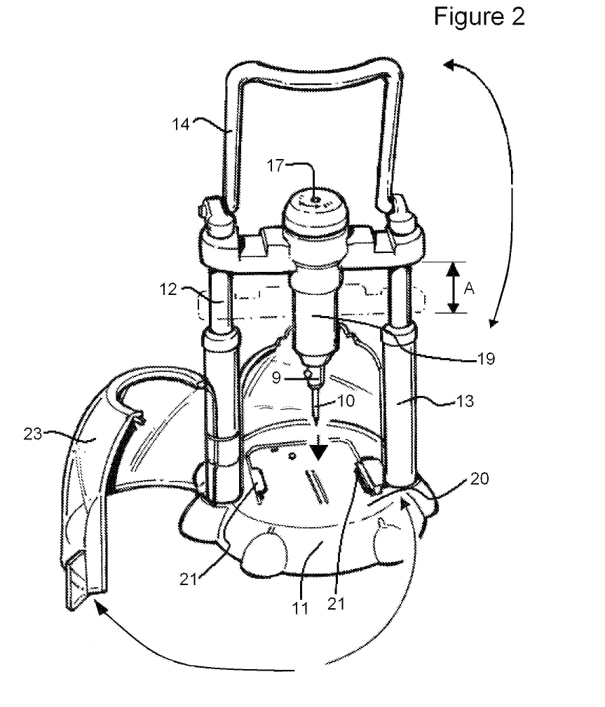

Referring now to FIG. 2, a view from the front of the device is shown with the containment door 23 in its open position and the handle 14 rotated upwardly. Before drilling begins, the handle is first rotated so that it extends forwardly against the top of the motor frame, as shown by the arrows in this Figure. It is adapted for grasping by the operator so that the drill 17 may be lowered and raised the distance indicated by the operating range “A”. A drill bit 10 including a shank 9 extends from the spindle. As seen in this Figure, the containment cover door 23 encompasses approximately half of the containment chamber so that when in it is in the open position, as shown, the entire support surface 20 of the base 11 is accessible. The support surface 20 further includes slide attachment means 21 for receiving a reservoir basin.

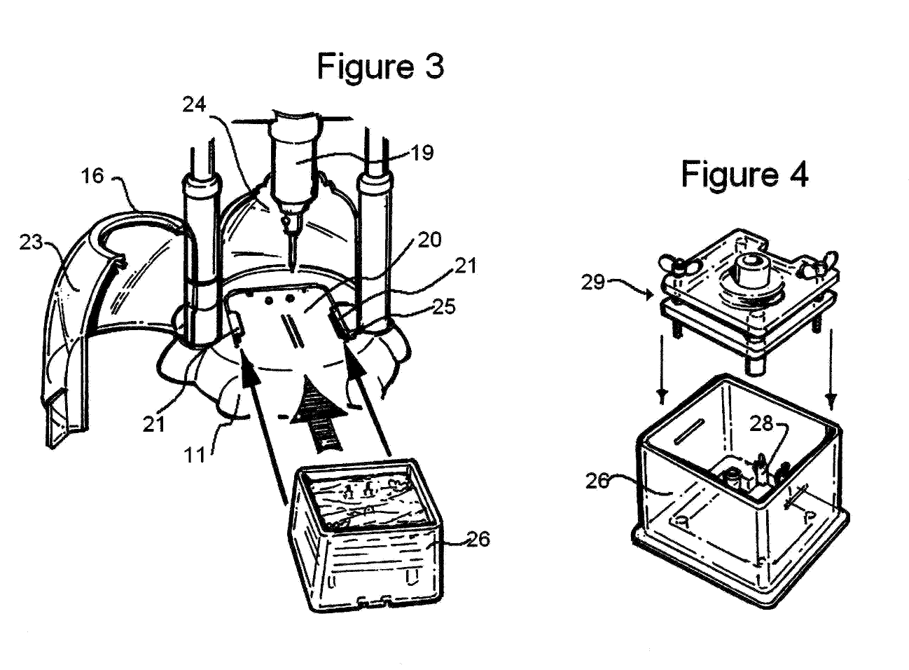

Referring now to FIG. 3, the water reservoir basin 26 is slideably attachable to the top support surface 20 of the base 11 by slide attachment means 21. A safety switch 25 is operable to sense a fully closed position to a containment door 23. A cylindrical spindle housing 19 is closely received within the containment cover opening 16 formed by the mating semicircular halves of the containment door 23 and the remainder of the containment cover 24.

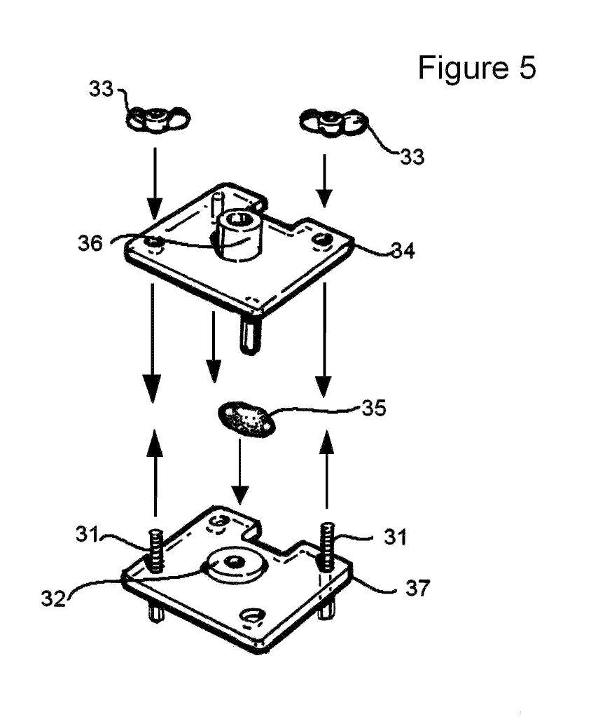

Referring now to FIG. 4, extending from the base of the water reservoir basin 26 are liquid-presence sensing means 28 which indicate the water level within the basin. The basin cooperates with the clamping means 29 shown in more detail in FIG. 5. The clamping means 29 is securely mounted within the reservoir basin 26.

Referring now to FIG. 5, the clamping means includes an upper clamping plate 34 and a lower clamping plate 37 which are screwed tightly together by threaded studs 31 and wingnuts 33. An elastomeric support surface 32 is centered on the lower clamping plate 37 and securely holds workpiece rock 35. A drill guide bushing 36 is located on the upper clamping plate and closely receives a shank of the drill bit to precisely hold in alignment with the center of the workpiece rock 35.

The present invention is operated as follows: First, the operator opens the containment chamber door as shown in FIG. 2. The water reservoir/clamping plate assembly is slid forward to release it from the base. The clamping plate is then lifted up and out of the water reservoir. Two wingnuts on the top of the clamping plate are unscrewed so that the upper clamping plate can be removed. A rock is then selected to drill and placed on the lower clamping plate, centering it on the raised elastomeric cushion in the middle of the lower clamping plate. With the upper clamping plate aligned as to their respective notches and pins, the upper clamping plate 34 is lowered onto the lower clamping plate 37 and the wingnuts 33 tightened down until the rock 35 is held securely in place as shown in FIG. 5. The clamping plate assembly is then placed back into the water reservoir 26, which is then filled with water to the point at which the water level lies just over the top of the clamping plate as shown in FIG. 4. The clamping/water reservoir assembly is then slid back into the attachment means on the base support surface 20 and the containment door 23 is closed until it snaps into place, which activates the safety switch 25 so that the motor will operate as shown in FIG. 3. The water level sensor in the reservoir also will not permit operation of the drill if the reservoir is not full.

Drilling of the stone then proceeds by first lowering the drill bit down through the upper clamping plate bushing. Power to the drill motor is then turned on. The drill motor and bit are then moved slowly downward until the drill bit engages the rock to begin cutting. The drill bit is repeatedly lowered and raised for approximately five seconds at a time to keep it cool and to increase the longevity of the drill bit. Once the cutting is finished and the rock is cut through, the drill assembly is withdrawn and the motor turned off. The containment door is then opened and the reservoir assembly is released from the base. Water is then emptied from the reservoir and the top clamping plate is unscrewed to release the drilled stone.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A drill press for gemstones comprising:
a base having a top support surface;
a plurality of vertical tower sleeves affixed to said base;
a plurality of telescoping rods extending from said sleeves;
a frame rigidly affixed to said rods;
a drill affixed to said frame comprising a motor having a housing, a spindle extending downwardly from said motor enclosed by a substantially cylindrical spindle housing, and a drill bit affixed to said spindle; and
a containment cover affixed to said base, said cover having a hinged door for gaining access to a work area enclosed by said cover, said cover further including a circular opening at the top closely receiving said spindle housing.

2. The drill press of claim 1 further including a water basin releasably affixed to said base in said work area enclosed by said cover, said basin being removable through said cover door.

3. The drill press of claim 2 further including clamp means within said basin for holding a stone workpiece.

4. The drill press of claim 3 wherein said clamp means comprises a top clamp plate having a guide bushing closely receiving a shank of said drill bit.

5. The drill press of claim 2 further including liquid-presence sensor means for detecting a minimum amount of water within said basin, said sensor electrically connected to said motor such that the motor will not operate without a sufficient amount of said water in said basin.

6. The drill press of claim 1 further including safety switch means operable in conjunction with said door and electrically connected to said motor such that the motor will not operate unless said door is in a fully closed position.

7. The drill press of claim 1 further including a handle affixed to said frame, said handle being rotatable between stored and operable positions, said handle adapted for grasping by an operator for moving said drill bit reciprocally within said work area.

8. The drill press of claim 1 wherein said cover is transparent.

9. The drill press of claim 8 wherein said cover is dome shaped.

10. The drill press of claim 1 having only two tower sleeves located on opposite sides of said cover.
